(19) United States
(12) Patent Application Publication
(10) Pub. No.: US 2008/0065605 A1
(43) Pub. Date: Mar. 13, 2008

(54) Rich browser-based interface for address standardization and geocoding

(75) Inventors: Freddie J. Bourland, Longmont, CO (US); Stephen C. Walden, Longmont, CO (US); Christopher A. Baker, Annapolis, MD (US)

Correspondence Address: PITNEY BOWES INC.;35 WATERVIEW DRIVE, P.O. BOX 3000, MSC 26-22, SHELTON, CT, 06484-8000, US

(73) Assignee: Group 1 Software Inc., Lanham, MD (US)

(21) Appl. No.: 11/647,964

(22) Filed: Dec. 28, 2006

Related U.S. Application Data
(60) Provisional application No. 60/843,041, filed on Sep. 8, 2006.

(51) Int. Cl. G06F 17/30

(52) U.S. Cl. 707/3

(57) ABSTRACT

A method of interfacing data entry to an address matching engine includes of entering into a client processing system browser locale data for an address and entering into the client processing system browser an alphanumeric value of the street portion of said address. The client processing system sends to a web service after each entry of an alphanumeric value of the street portion of the address, the entered locale data and the entered alphanumeric street portion of the address. At the web service based on the entered locale data and the entered alphanumeric street portion of the address, searching is implemented for potential address matches. Any potential address matches obtained by the web service are returned from the web service to the client processing system in such a manner that any address matching session is maintained on the client processing system. The alphanumeric data entering step, the sending to a web service step, the searching at said web service step and the returning to said client processing system step are repeated to refine potential address matches. These repeated steps may be stopped when one address is selected from the potential address matches.

### RELATED APPLICATIONS

This application claims the benefit under 35 U.S.C. 119(e) of U.S. provisional patent application Ser. No. 60/843,041 filed Sep. 8, 2006, and entitled “A RICH BROWSER-BASED INTERFACE FOR ADDRESS STANDARDIZATION AND GEOCODING”, which is incorporated herein by reference.

### BACKGROUND OF THE INVENTION

Studies indicate that as many as 40% of addresses entered in a web interface have errors or missing elements. This problem has been usually handled in one of two ways, standardization engine systems and interactive systems.

In standardization engine systems, the entered address is passed to a standardization engine that considers the input address and matches it to the best address in a reference data set. If the reference address differs from the entered address then the address is presented to the user for approval. If no best reference is found, then an error message is presented to the user with suggestions to correct the input, or possibly suggested addresses that might be matches for the input address. The drawback to this approach is that it is modal in nature. The user enters an address in its entirety before any analysis is performed. Then the user must correct errors or accept changes and resubmit the form. This process repeats until the user has entered a complete and correct address. This is especially challenging to the user when the address is only a small portion of a larger form, which is usually the case. Often the user must hunt for problems in a large page or resubmit an entire page for a small error. In addition, the feedback loop between user and the address matching engine is very onerous, since the user must submit the form before getting any feedback.

Interactive systems for entering addresses also exist today. They typically consist of an ActiveX or Java control into which the user enters information. The information uses the structured information present in an address to drill down to the exact method. In a drill down method the user is asked to enter data at a gross geographic level and is given choices to select at the next finest level. The user will enter a state and be given a choice of cities to select from; after a city is selected the user is given a list of street names from which to select and so on. There are two drawbacks to this approach. The first is the use of an external control instead of native web technologies like HTML and JavaScript. The use of a control has security implications and there are portability problems as well. Many installations will not allow their users to download unknown ActiveX or Java controls because many viruses and other malware propagate through them. In addition, the ActiveX controls will run only on computers running Microsoft Windows. The control often has a different look and feel from the rest of the web application, which can lead to a disjointed look for the application or even confuse some users. The second drawback to this approach is the hierarchical data entry. This may requiring a user to input elements of an address in the bottom up fashion which is unnatural to most users. This leads to user dissatisfaction or adds to potential errors.

### SUMMARY OF THE INVENTION

It is the object of the present invention to provide an interactive user interface to an address matching engine that presents options to the user as the user types the address in a natural form.

It is a further object of the present invention to provide a user feedback arrangement for an interface that allows the user to choose the correct address with minimal keystrokes.

It is yet another object of the present invention to employ an Asynchronous JavaScript and XML (AJAX) and rich address searching to create a web interface that returns accurate addresses with minimal input keystrokes.

A method of interfacing data entry to an address matching engine embodying the present invention includes the steps of entering into a client processing system browser locale data for an address and entering into the client processing system browser an alphanumeric value of the street portion of the address. The client processing system sends to a web service after each entry of an alphanumeric value of the street portion of the address, the entered locale data and the entered alphanumeric street portion of the address. At the web service based on the entered locale data and the entered alphanumeric street portion of the address searching is implemented for potential address matches. Any potential address matches obtained by the web service are returned by the web service to the client processing system in such a manner that the state of any address matching session is maintained on the client processing system. The alphanumeric data entering step, the sending to a web service step, the searching at said web service step and the returning to said client processing system step are repeated to refine the potential address match.

In accordance with the an aspect of the present invention the alphanumeric data entering step, the sending to a web service step, the searching at said web service step and the returning to said client processing system step are stopped when one address from the potential address matches is selected.

A method of interfacing data entry to an address matching engine also embodying the present invention includes the steps of registering with a key press event handler the address entry field on a web page and entering locale information into the address entry field and entering alphanumeric values of a street address information into the address entry field. A determination is made if the street address information in the address entry field contains two alphanumeric values separated by a space. Calling a web service is implemented when the address field contains street address information having at least two alphanumeric values separated by a space, with the locale information and the street address information from the web page. The web server calls an address lookup server to obtain candidate addresses from the address lookup server that match the locale information and the street address information from the web page. The web service formats any obtained candidate addresses that match the entered locale information and the entered street address information from the web page and returns any such formatted information to the client processing system browser in such a manner that the state of any address matching session is maintained on the client processing system.

### DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention. As shown throughout the drawings, like reference numerals designate like or corresponding parts.

FIG. 1 is an example of returned address information exhibited on a monitor operating as shown in the flowchart of FIG. 3 and embodying the present invention;

FIG. 2 is another example of returned address information exhibited on a monitor operating as shown in the flowchart of FIG. 3 and also embodying the present invention but organized in a different format than shown in FIG. 1; and,

FIG. 3 is a flowchart of the operation of the browser-based interface for address standardization and geocoding shown in FIGS. 1 and 2.

### DETAILED DESCRIPTION OF THE PRESENT INVENTION

In describing the present invention, reference is made to the drawings, wherein there is seen in Figs. The monitor 100 of the browser based interface includes a text box 102 that will be used to enter information. The user enters the minimum information in the text box 102. This information may be at least 3 digits of a ZIP code, enough of a city name to contain the soundex value for the complete city name, or a combination of city, state and ZIP code information. The soundex value is a phonic algorithm for indexing names by their sound when pronounced in English. Any suitable phonic algorithm can be employed. The user begins to type the address line in the text box 104. The key up event handler sends the contents of the last line field and the address line to a REST-style web service.

A system which follows the REST-style web service has clients that initiate communication, sending request messages to servers, which respond with response messages. The REST-style web service maintains the state of any given session on the client, not on the server; and, communicates the state in request messages at a level sufficient to let a server understand and correctly process the request messages. The web service URL will be in any standard form such as:

http://servername/centrus/lookup?addressline=<input1>&lastline=<input2>. In such case, <input1> and <input2> are replaced by the appropriate values from the text boxes of the web page.

The web service parses the parameter data and passes the information to an addressing module for processing. One such addressing module is Centrus AddressBroker™ which is a Real-time address standardization and geocoding product marketed by Pitney Bowes Group 1 Software. The address information is compared to the reference data and one or more candidate records are found. The returned address list is transformed to JavaScript Object Notation (JSON) and returned to the calling function. The data elements returned include, but are not necessarily limited to, the United States Postal Service (USPS) firm name, address line, last line, longitude, latitude, location code and USPS range record type. In addition, a unique ID is assigned to each address element in the address list.

In the web page, the returned information is parsed and displayed on the web page. The possible candidate records are shown as returned address 106, 108, 110, 112, 114 and 116. The process of the key-up event handler sending the contents until a return occurs is repeated, as described above, for each keystroke in the address text box. Thus the returned matched address information is refined with each alphanumeric entry, keystroke by keystroke. The user may highlight and select one of the returned addresses 106 through 116, or continue to enter further information to get additional address candidates listed on the list of displayed possibilities on monitor 130.

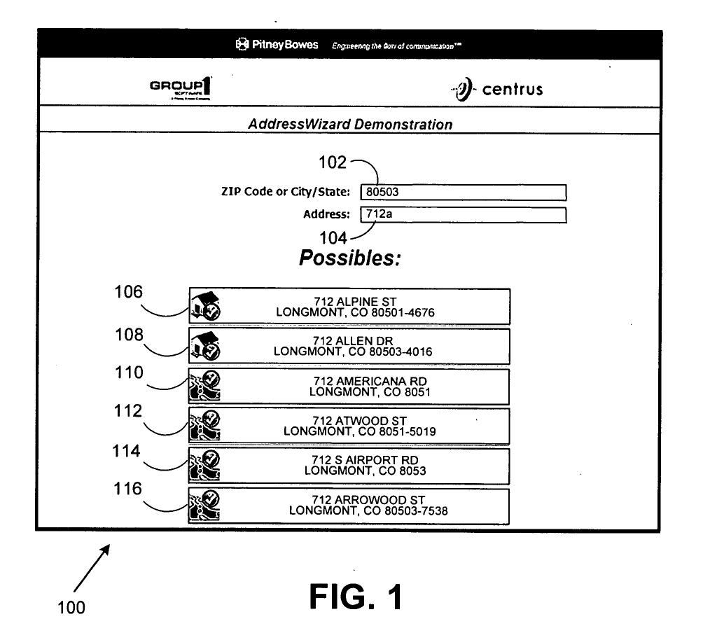

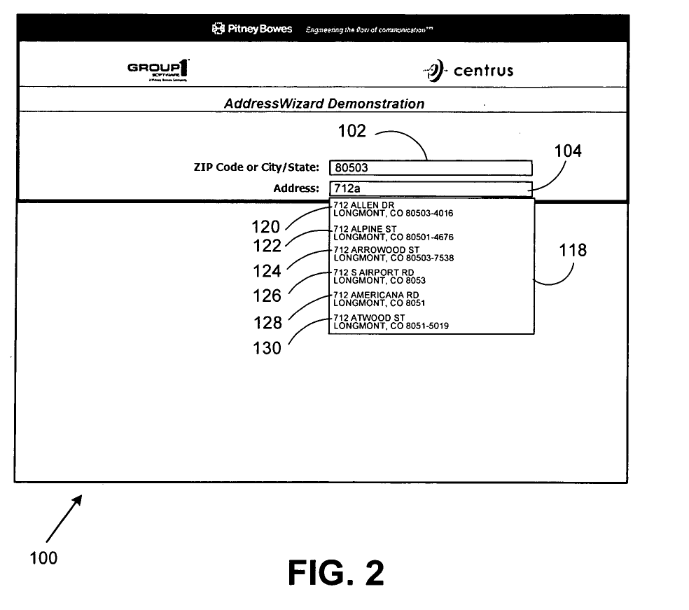

Reference is now made to FIG. 2. The returned matched address information is organized in a different format of address candidates listed than on the list of displayed possibilities than shown in FIG. 1. The returned information is presented in a drop-down box 118. The list of address candidates 120, 122, 124, 126, 128 and 130 are displayed in the drop-down box 118 for selection by the user.

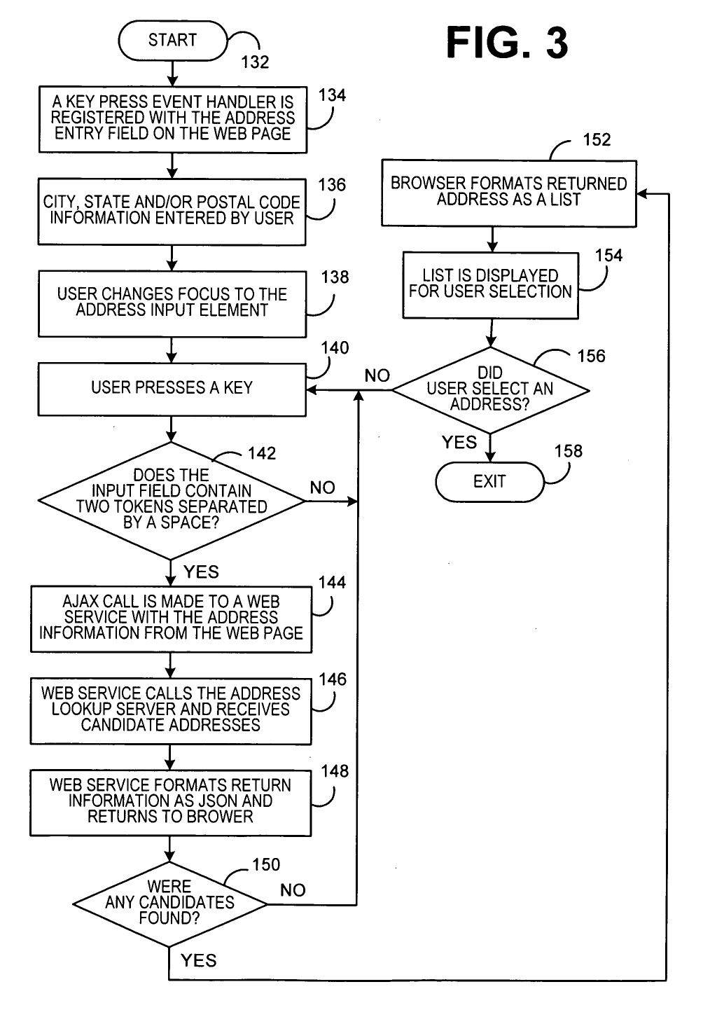

Reference is now made to FIG. 3. The operation of the browser-based interface for address standardization and geocoding shown in FIGS. 1 and 2 starts at block 132. At the client processing system a key press event handler is registered with the address entry field on a web page at block 134. At block 136, the city, state and/or postal code such as ZIP code information is entered by the user. The user changes focus to the address input element at 138 and the user presses a key to enter data at block 140. The address entry field is composed of text box 102 and text box 104 shown in FIGS. 1 and 2.

A determination is made at decision block 142 if the input field contains two tokens (two alphanumeric values) separated by a space. That is, two keystrokes separated by a space. If this not the case, that is, the input field does not contain two tokens, two alphanumeric entries, separated by a space, the program loops back to block 140 and the user enters another alphanumeric such as by a keystroke on a data entry keyboard or other device. If, however, the input field does contain two tokens separated by a space, at block 144, a call such as an AJAX-type call is made from the users processing system, the client, to a web service with the address information from the client's web page. AJAX stands for Asynchronous JavaScript and XML. AJAX is a standard web development technique for creating interactive web applications so that an entire web page does not have to be reloaded each time the user makes a change as is the case with the call at block 144. The web service calls the address look-up server and receives candidate records (i.e. candidate addresses) at block 146. At block 148, the web service formats return information such as in JSON, a JavaScript Object Notation, and returns the formatted information to the browser of the client processing system.

A determination is made at decision block 150 if any candidate records, addresses, were found. If no candidate address has been found, the process loops back to block 140 and the user enters another alphanumeric to enter further data. If candidate addresses have been found at decision block 150, the browser at the client processing system formats the returned address(es) as a list at block 152. The list is displayed for user selection at block 154. This would be in the format of the list of candidate address matches as shown in FIGS. 1 and 2. A determination is made at block 156 if the user selected an address from the displayed list. If the user did not select an address from the displayed list, the process loops back to block 140 and the user again enters an alphanumeric. Once the process because there are two alphanumeric entries separated by a space, each further entry of an alphanumeric continues the process. If the user has selected an address from the displayed list, the process exits at block 158. Additionally, If there is an exact match or the only possible match to the user entered address, the process may also be operated to exit at block 158.

The browser-based interface system thus provides an interactive browser-based interface that reacts to user entered keystrokes entering alphanumeric data into the client processing system. The browser-based interface system will return a list of standardized and geocoded addresses to the browser to be displayed to the user. The user can refine the list with further alphanumeric data entry, correct errors, or select a candidate from the list. The browser-based interface system creates an interactive interface that presents options to the user as the user types the address in a natural form. Natural form means that the entry of the address line is based on a scan of the address from left to right in the manner that the address is typically written or spoken. This contrasts with hierarchical form used in most systems where the user enters the street name and then “drills down” to the street type, directional prefix and/or suffix, and house number. This creates an instant feedback mechanism to allow the user to choose the correct address with minimal keystrokes.

In operation, the user types in a ZIP Code or portion of a city and state. The user then begins to enter the street portion of the address in its natural form. After the key is released from each keystroke, the last line information (city & state or ZIP Code) and the address information are sent for processing to a web service. The web service searches for potential matches in a reference dataset. The list of potential matches is returned to the web page where it is displayed for selection by the user. The search is repeated and refined with each keystroke by the user until the user selects one address from the list or only one address is possible.

Information is returned interactively in real time. The user does not have to drill down to the address through a hierarchy of streets and numbers, but merely types the address in its natural form. There is no control needed to display the information—it is handled portably according to browser standards. The look and feel address entry portion of a web page is at the discretion of the web designer, ensuring a consistent experience for users.

The browser-based interface system includes three parts: a JavaScript library to mediate the communication with the web page; a REST-style Web Service to process JavaScript requests; and, a server with point and centerline data loaded for address hygiene and geocoding such as the Centrus AddressBroker™.

The processing proceeds with a key up event handler being registered with the text box that will be used to enter the address line information. The then user enters the minimum information necessary in a first text box. This information as previously noted may be at least three digits of the ZIP code, enough of the city name to contain the soundex value for the complete city name, or a combination of city, state and ZIP information.

The user thereafter begins to type in the address line of the address text box and the key up event handler sends the contents of the last line field and the address line to a REST-style web service. The web service parses the parameter data and passes the information to a server with point and centerline data loaded for address hygiene and geocoding for processing. The address information is compared to the reference data and one or more candidate records are found. The logic used for the lookup is described below.

The logic used for the lookup of candidate records proceeds with the returned address list transformed to JavaScript Object Notation (JSON) and returned to the calling function. As previously noted, the data elements returned include (but are not limited to) USPS Firm Name, Address Line, Last Line, Longitude, Latitude, Location Code, and USPS Range Record Type. In addition, a unique id is assigned to each address element in the address list. In the web page, the returned information is parsed and displayed on the web page. The process is repeated with the event handler through the display of returned information for each user keystroke in the address line text box.

The processing at the server with point and centerline data loaded for address hygiene and geocoding to determine candidates for partial addresses operates as follows. The last line information is parsed, and a ZIP Code is extracted if one exists. If a ZIP Code is found, then that is used to determine a Finance Area for the search. If only 3 digits of a ZIP Code are entered, then all Finance Areas associated with the 3 digit area are used as the search area. A Finance Area is a search area based on a group of ZIP or other postal codes.

If a ZIP Code is not identified, then the city or city and state information is examined. If a complete city and state is entered and that information is matched to data in the city state table from the USPS, then the Finance Area or Areas corresponding to the input city and state are used in the search. If a lone city name or partial city name is entered then the soundex of the city name is computed and all city and state combinations whose city name has a matching soundex value are used as the search area. The address line is parsed and a house number and street name are extracted from the parsing. If the address line does not contain a house number and at least one other token (alphanumeric) to be interpreted as the beginning of the street name, then the process exits and no information is returned to the client.

The soundex value of the partial street name identified above is computed. The portions of the reference data set that corresponds to the Finance Areas are searched for all streets for which the soundex value of the street name match the soundex computed from the input partial street name. The matches are only required on those values contained in the soundex value of the input street name. For example, if the input partial street name contains only one letter, then all street names with the same first letter are accepted.

Each street name found in is filtered by determining whether the house number extracted above is found on the street. Streets whose house ranges do not allow the input house number are discarded. All others are returned to the user. Finally, if the possible addresses for the input partial address belong to multiple locations, then each potential primary address is returned. If the input resolves to a single primary address with no secondary information, then that single result is returned. If the input information resolves to a single primary address, but primary address contains secondary locations according to the reference data, then multiple returns are made corresponding to each range of secondary information present in the reference data.

In above manner, the user is presented with a list of potential addresses that correspond to the typed input. The list becomes more precise as more of the address is entered until only one candidate remains, or the user selects the appropriate address from a list of returned values. In practice, most addresses are resolved after only 2 or 3 letters of the street name are entered.

While the present invention has been described in connection with what is presently considered to be the most practical and preferred embodiments, it is to be understood that the invention is not limited to the disclosed embodiment, but, on the contrary, is intended to cover various modifications and equivalent arrangements included within the spirit and scope of the appended claims.

What is claimed is:

1. A method of interfacing data entry to an address matching engine, comprising the steps of:
entering into a client processing system browser locale data for an address;
entering into said client processing system browser an alphanumeric value of the street portion of said address;
sending from said client processing system to a web service after each entry of an alphanumeric value of said street portion of said address, said entered locale data and said entered alphanumeric street portion of said address;
searching at said web service for potential address matches based on said entered locale data and said entered alphanumeric street portion of said address;
returning from said web service to said client processing system any potential address matches obtained by said web service in such a manner that the state of any address matching session is maintained on said client processing system; and,
repeating said alphanumeric data entering step, said sending to a web service step, said searching at said web service step and said returning to said client processing system step to refine potential address matches.

2. A method of interfacing data entry to an address matching engine as defined in claim 1, comprising the further step of stopping said repeating step when one address from the said potential address matches is selected.

3. A method of interfacing data entry to an address matching engine as defined in claim 1, comprising the further step of stopping said repeating step when only one address match is possible.

4. A method of interfacing data entry to an address matching engine as defined in claim 1 comprising the further step of displaying any potential address matches obtained by said web service.

5. A method of interfacing data entry to an address matching engine as defined in claim 4, comprising the further step of stopping said repeating steps when one address from the said potential address matches is selected.

6. A method of interfacing data entry to an address matching engine as defined in claim 5, comprising the further step of stopping said repeating step when only one address match is possible.

7. A method of interfacing data entry to an address matching engine as defined in claim 5, wherein said entered locale data for said address and said entered street portion of said address are displayed on a web page for viewing by a user.

8. A method of interfacing data entry to an address matching engine as defined in claim 7, wherein said returned potential address matches obtained by said web service are displayed on said web page for viewing by a user.

9. A method of interfacing data entry to an address matching engine as defined in claim 8, wherein said web service formats potential address matches returned by said web service to said client processing system in a JavaScript Object Notation format.

10. A method of interfacing data entry to an address matching engine as defined in claim 9, wherein said step of sending to a web service is first commenced after entry of two alphanumeric values separated by a space and subsequently after entry of each additional alphanumeric value.

11. A method of interfacing data entry to an address matching engine as defined in claim 10, wherein said entered locale data for an address is a locale postal code.

12. A method of interfacing data entry to an address matching engine, comprising the steps of:
registering with a key press event handler the address entry field on a web page;
entering locale information into said address entry field;
entering alphanumeric values of a street address information into said address entry field;
determining if said street address information in said address field contains two alphanumeric values separated by a space;
calling a web service when said address field contains street address information having at least two alphanumeric values separated by a space, with the locale information and said street address information from said web page;
calling by said web server an address lookup server to obtain from said address lookup server candidate addresses that match said locale information and said street address information from said web page; and,
formatting at said web service any obtained candidate addresses that match said entered locale information and said entered street address information from said web page and returning any such formatted information to said client processing system browser in such a manner that the state of any address matching session is maintained on said client processing system.

13. A method of interfacing data entry to an address matching engine as defined in claim 12, wherein said step of calling said web service is first commenced after entry of two alphanumeric values separated by a space and subsequently after entry of each additional alphanumeric value.

14. A method of interfacing data entry to an address matching engine as defined in claim 13, comprising the further steps of:
determining if any candidate addresses were found; and,
when no candidate addresses are found waiting for another alphanumeric value of street address information to be entered into said address field and repeating said steps of calling to said web service step, calling said address lookup server step, and formatting at said web service obtained candidate addresses step.

15. A method of interfacing data entry to an address matching engine as defined in claim 13, comprising the further steps of
determining if any candidate addresses were found; and,
when candidate addresses are found and are returned to said client processing system browser, formatting as a list at said client processing system said found, returned candidate addresses.

16. A method of interfacing data entry to an address matching engine as defined in claim 13, comprising the further steps of:
determining if any candidate addresses were found;
when no candidate addresses are found waiting for another alphanumeric value of street address information to be entered into said address field and repeating said steps of calling to said web service step, calling said address lookup server step, and formatting at said web service obtained candidate addresses step; and,
when candidate addresses are found and are returned to said client processing system browser, formatting as a list at said client processing system said found, returned candidate addresses.

17. A method of interfacing data entry to an address matching engine as defined in claim 16, comprising the further step of displaying for user selection said list of candidate addresses.

18. A method of interfacing data entry to an address matching engine as defined in claim 17, comprising the further step of when a user selects a candidate address from said list of displayed candidate addresses, stopping said repeating said steps of calling to said web service step, calling said address lookup server step, and formatting at said web service obtained candidate addresses step.

19. A method of interfacing data entry to an address matching engine as defined in claim 18, wherein said web service formats candidate address matches returned by said web service to said client processing system in a JavaScript Object Notation format.

20. A system of interfacing data entry to an address matching engine, comprising:
means for entering into a client processing system browser locale data for an address;
means for entering into said client processing system browser an alphanumeric value of the street portion of said address;
means for sending from said client processing system to a web service after each entry of an alphanumeric value of said street portion of said address, said entered locale data and said entered alphanumeric street portion of said address;
means for searching at said web service for potential address matches based on said entered locale data and said entered alphanumeric street portion of said address;
means for returning from said web service to said client processing system any potential address matches obtained by said web service in a manner such that the state of any address matching session in maintained on said client processing system; and,
means for repeating said alphanumeric data entering step, said sending to a web service step, said searching at said web service step and said returning to said client processing system step to refine potential address matches.
